(19) United States
(12) Patent Application Publication
(10) Pub. No.: US 2005/0225438 A1
(43) Pub. Date: Oct. 13, 2005

(54) Message reporting devices

(76) Inventor: Kung Hsieh Wang, Taipei City (TW)

Correspondence Address: BIRCH STEWART KOLASCH & BIRCH, PO BOX 747, FALLS CHURCH, VA, 22040-0747, US

(21) Appl. No.: 11/003,442

(22) Filed: Dec. 6, 2004

(30) Foreign Application Priority Data
Apr. 8, 2004 (TW) 93109717

(51) Int. Cl. G08B 1/00

(52) U.S. Cl. 340/309.7; 340/309.16

(57) ABSTRACT

Message reporting devices are provided. A message reporting device includes a timer, a memory, a voice input module, a voice output module, an input module, a functional switch, and a logic controller, characterized in that the timer generates current time, the voice input module converts audio input to a digital message, and the memory stores reminder tags and digital messages corresponding thereto, wherein when the functional switch is switched to message record mode, the logic controller stores a reminder tag input from the input module and a corresponding digital message input from the voice input module to the memory, and when switched to message reminder mode, when a reminder tag corresponds with the current time, the logic controller directs the voice output module to play a digital message stored in the memory corresponding to the matching reminder tag.

### BACKGROUND

The invention relates to message reporting devices.

Presently, recording and storage of personal information, such as schedule and appointment data, utilizes electronic devices, such as answering machines. Conventionally, users must activate controls manually to review recorded information. This represents inconvenience for users.

### SUMMARY

Message reporting devices are provided. An exemplary embodiment of a message reporting device comprises a timer, a memory, a voice input module, a voice output module, an input module, a functional switch, and a logic controller. The voice input module converts audio input to a digital message, and the memory stores a plurality of reminder tags and a plurality of digital messages corresponding thereto, wherein when the functional switch is switched to message record mode, the logic controller stores reminder times input using the input module, with corresponding digital messages input using the voice input module. When the functional switch is switched to message reminder mode, when a reminder tag corresponds with the current time, the logic controller directs the voice output module to play any digital messages stored in the memory corresponding to the matching reminder tag.

The timer is a clock chip. The memory is a flash memory. The voice input module comprises a microphone and a digital recording chip converting analog audio input to a digital message. The voice output module is a speaker. The input module can comprises a plurality of keys such as a standard keyboard. The logic controller is a micro-controller.

The message reporting device further comprises an alarm, wherein when the functional switch is switched to message reminder mode upon playback, the logic controller enables the alarm, for example a lamp alarm or oscillator.

The message reporting device further comprises a display module such as a liquid crystal display (LCD) module or utilizes a plurality of seven-segment displays.

### DESCRIPTION OF THE DRAWINGS

The invention can be more fully understood by reading the subsequent detailed description and examples with references made to the accompanying drawings, wherein:

FIG. 1 is a block diagram of an embodiment of a message reporting device.

FIG. 2 is a flowchart showing operation of a message record mode.

FIG. 3 is a flowchart showing operation of a message reminder mode.

### DETAILED DESCRIPTION

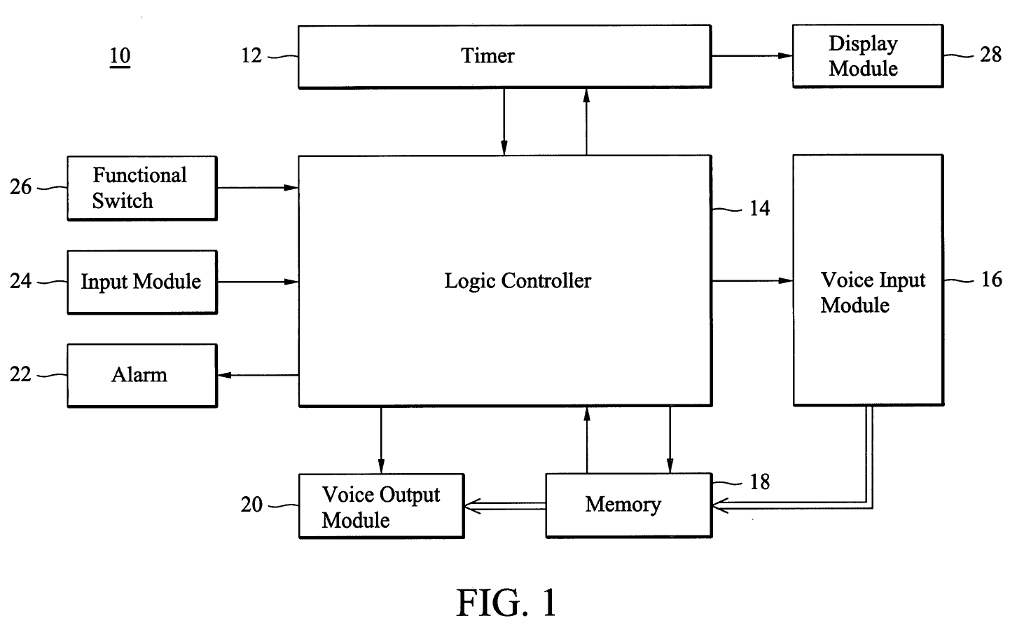

Message reporting devices will be described in greater detail in the following. FIG. 1 is a block diagram of an embodiment of a message reporting device. As shown, the message reporting device is a digital device, capable of playing previously recorded messages according to a preset schedule. The message reporting device comprises a timer 12, a logic controller 14, a voice input module 16, a memory 18, a voice output module 20, an alarm 22, an input module 24, a functional switch 26, and a display module 28.

The timer 12 is a clock chip providing current time, shown by the display module 28.

The voice input module 16 is a digital recording module comprising a microphone and a digital recording chip. Analog audio input received from the microphone is converted to a digital message by the digital recording chip and transmitted to the memory 18 for storage.

The memory 18 can be a flash memory or any compatible memory, storing a plurality of reminder tags and a plurality of digital messages corresponding thereto.

The voice output module 20 comprises a digital-to-analog conversion (DAC) circuit and a speaker. Digital messages stored in the memory 18 are re-converted to analog signals and played back through the speaker.

The input module 24, comprising a plurality of keys, can be a standard keyboard. Through the input module 24, users can input the reminder tags, modify the reminder tags, or set the clock chip.

The functional switch 26 can be a switch or a button for switching between operating modes of the message reporting device 10.

The display module 28 can be a liquid crystal display (LCD) module or utilize a plurality of seven-segment displays for displaying the current time transmitted from the timer 12.

The logic controller 14 is a micro-controller controlling the above modules. When the functional switch 26 of the message reporting device 10 is switched to message record mode, the logic controller 14 stores a reminder tag input from the input module 24 to a specific address in the memory 18. The logic controller 14 then stores a corresponding digital message input from the voice input module 16 to the memory 18, thereby completing message recording.

When the functional switch 26 of the message reporting device 10 is switched to message reminder mode, when a reminder tag stored in the memory 18 corresponds with the current time generated by the timer 12 according to comparison by the logic controller 14, the logic controller 14 enables the voice output module 20. Thus, the DAC chip converts the digital messages stored in the memory 18 to analog signals, and the speaker then plays the analog signals. Therefore, the message reporting device 10 is able to play previously recorded messages according to a preset schedule, thereby completing message reminding.

The message reporting device 10 further comprises an alarm 22. The alarm 22 is an oscillator or a lamp alarm. When the functional switch 26 is switched to message reminder mode, when a reminder tag corresponds with the current time, the logic controller 14 enables both the voice output module 20 and the alarm 22. Thus, when the voice output module 20 plays previously recorded messages, the alarm 22 vibrates or emits light to attract users.

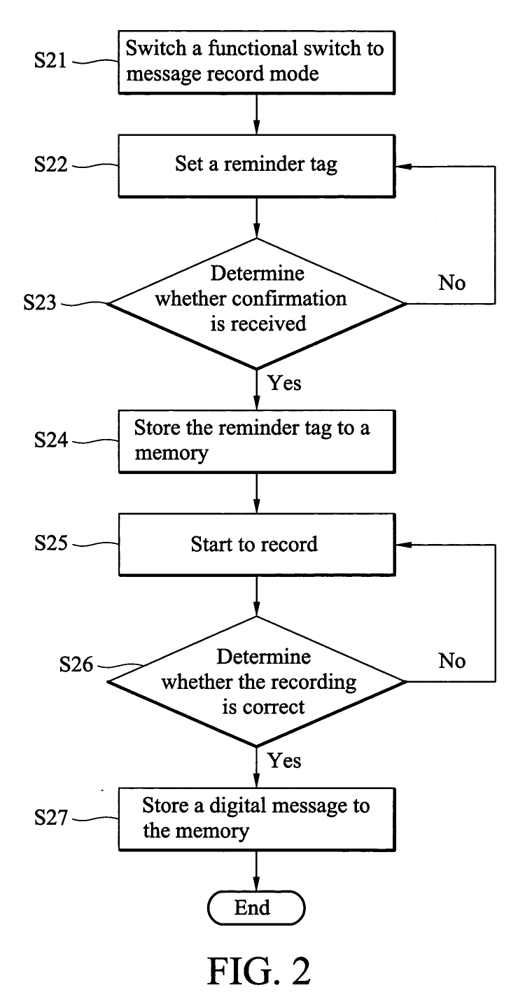

FIG. 2 is a flowchart showing operation of a message record mode. First, the functional switch 26 is switched to message record mode (S21). A reminder tag is set through the input module 24 (S22). The logic controller 14, i.e. the micro-controller 14, waits for confirmation input by users (S23). If the confirmation is received, the logic controller 14 stores the input reminder tag to the memory 18 (S24). If not, the logic controller 14 awaits input.

Next, the logic controller 14 directs the voice input module 16 to begin recording via the microphone and the digital recording chip, and recorded digital messages are stored to a temporary address in the memory 18 (S25). After a preset period, the voice input module 16 stops recording and waits for users to determine whether the recording is correct (S26). If so, users confirm through the input module 24, and the logic controller 14 stores the input digital message to a preset address in the memory 18 for storage (S27).

In an embodiment, the memory 18 or the voice input module 16 can utilize a dynamic random access memory (DRAM) of sufficient volume to provide the temporary address, thereby accelerating message storage.

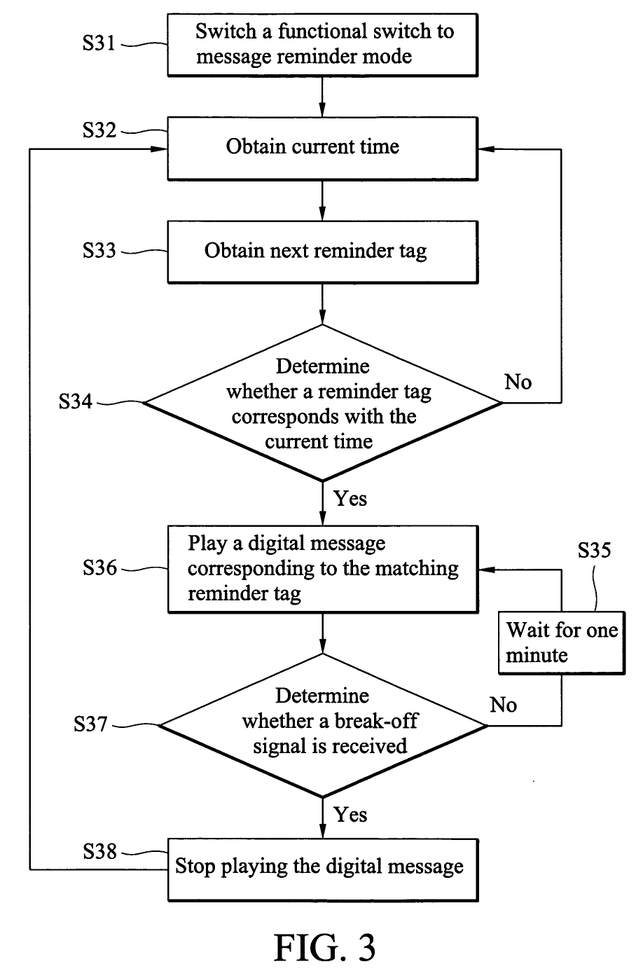

FIG. 3 is a flowchart showing operation of a message reminder mode. First, the functional switch 26 is switched to message reminder mode (S31). The logic controller 14 obtains the current time from the timer 12 (S32). Also, the logic controller 14 obtains a reminder tag from the specific address in the memory 18 (S33). Then, the logic controller 14 compares the current time with the reminder tag to determine whether the current time matches the reminder tag (S34). If so, the logic controller 14 directs the voice output module 20 to play a digital message corresponding to the matching reminder tag (S36). If not, the process returns to step S32.

When the voice output module 20 plays the previously recorded digital message, the logic controller 14 awaits a break-off signal input from the input module 24 (S37). If the break-off signal is received, indicating the user has heard the previously recorded digital message and confirmed via the input module 24, the voice output module 20 stops playback of the previously recorded digital message (S38) Then, the process returns to step S32.

If the break-off signal is not received before the voice output module 20 finishes the previously recorded digital message, indicating the user has not heard the message, the voice output module 20 replays the previously recorded digital message (S36) after a preset period, such as one minute (S35), thereby completing message reminding.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A message reporting device, comprising a timer, a memory, a voice input module, a voice output module, an input module, a functional switch, and a logic controller, characterized in that:
the timer generates current time;
the voice input module converts audio input to a digital message; and
the memory stores a plurality of reminder tags and a plurality of digital messages corresponding thereto,
wherein when the functional switch is switched to message record mode, the logic controller stores a reminder tag input from the input module and a corresponding digital message input from the voice input module to the memory, and when the functional switch is switched to message reminder mode, when a reminder tag corresponds with the current time, the logic controller directs the voice output module to play a digital message stored in the memory, corresponding to the matching reminder tag.

2. The message reporting device as claimed in claim 1, wherein the timer is a clock chip.

3. The message reporting device as claimed in claim 1, wherein the memory is a flash memory.

4. The message reporting device as claimed in claim 1, wherein the voice input module comprises a microphone and a digital recording chip.

5. The message reporting device as claimed in claim 1, wherein the voice output module is a speaker.

6. The message reporting device as claimed in claim 1, wherein the input module comprises a plurality of keys.

7. The message reporting device as claimed in claim 1, wherein the logic controller is a micro-controller.

8. The message reporting device as claimed in claim 1 further comprising an alarm, wherein when the functional switch is switched to message reminder mode, when a reminder tag corresponds with the current time, the logic controller enables the alarm.

9. The message reporting device as claimed in claim 8, wherein the alarm is a lamp alarm.

10. The message reporting device as claimed in claim 8, wherein the alarm is an oscillator.

11. The message reporting device as claimed in claim 1 further comprising a display module displaying the current time.

12. The message reporting device as claimed in claim 11, wherein the display module comprises a plurality of seven-segment displays.

13. The message reporting device as claimed in claim 11, wherein the display module is a liquid crystal display (LCD) module.
